(19) United States
(12) Patent Application Publication
(10) Pub. No.: US 2025/0308162 A1
(43) Pub. Date: Oct. 2, 2025

(54) TEXTURE-BASED GUIDANCE FOR 3D SHAPE GENERATION

(71) Applicant: Sony Interactive Entertainment LLC, San Mateo, CA (US)

(72) Inventor: Joseph Logan Olson, San Mateo, CA (US)

(21) Appl. No.: 18/623,967

(22) Filed: Apr. 1, 2024

(51) Int. Cl. G06T 17/20

(52) U.S. Cl. CPC G06T 17/20

(57) ABSTRACT

To make a computer-based 3D shape such as a mask, zones are painted on a target head indicating whether a particular zone is to be covered, super-covered, shown, or “don't care” (neutral either way). The coverage or non-coverage of these zones contribute to a loss function as the model is being generated. Essentially rewards and penalties are established for being able (or not) to see the parts that should be seen and not seeing the parts that should not be seen. Also, the model is penalized getting beyond a certain outer bounds. Further, the generation commences from a default mask to have a good starting point. Additionally, a foundation mask model is added to the final generation to cover up any remaining holes. In this way, 3D shapes are created with the correct constraints at a much higher rate.

### FIELD

The present application relates generally to texture-based guidance for 3D shape generation.

### BACKGROUND

A 3D neural radiance field (NeRF) may be thought of as a 3D volume stored in a machine learning (ML) model. As understood herein, the ML model can be trained to receive text descriptions of a desired object and in response produce images of objects such as characters and their accoutrements for computer simulations such as computer games. Once a NeRF has been produced it must typically be converted to a mesh for use in computer simulations.

As understood herein, when generating a 3D model of a head mask, typically parts of the head are desired to be covered (nose and ears) and other parts uncovered (e.g., eye holes). This same challenge is present in other 3D objects (especially around character customization) such as gloves, pants, or coffee mug koozie.

### SUMMARY

Present techniques are focused on 3D model generation for character customization, in a specific example, headgear such as masks. A 3D shape can be generated based on text but there are no built-in constraints for the shape. It is undesirable to generate 3D headgear that has unwanted holes/gaps in the mask such the nose sticking out or unwanted coverage such as the eyes being blocked. Present techniques use a head mesh the mask will actually cover. Zones are painted on the target head indicating whether the particular zone is to be covered, super-covered, shown, or “don't care” (neutral either way). The coverage or non-coverage of these zones contribute to the loss function as the model is being generated. Essentially rewards and penalties are established for being able (or not) to see the parts that should be seen and not seeing the parts that should not be seen.

In addition, three supplementary techniques are introduced. First, the model is penalized for getting beyond a certain outer bounds. Co-owned U.S. patent application Ser. No. 18/345,336, filed Jun. 30, 2023 for “USING POLYGON MESH RENDER COMPOSITES DURING NEURAL RADIANCE FIELD (NERF) GENERATION” and incorporated herein by reference provides example related techniques.

Second, the generation commences from a default mask to have a good starting point. Third, a foundation mask model is added to the final generation to cover up any remaining holes. In this way, 3D shapes are created with the correct constraints at a much higher rate.

Accordingly, a method includes using a computer for associating plural zones on a target mesh with respective indications, each indicating whether the respective zone is to be covered or not covered by a 3D head covering. The method also includes using coverage or non-coverage of the zones as a model of the 3D head covering is being generated such that at least one reward in model generation is established for being able to see parts that should be seen and for not being able to see parts that should not be seen and at least one penalty in model generation is established for not being able to see parts that should be seen and for being able to see parts that should not be seen. The method includes outputting an image of the 3D head covering.

In example embodiments, the method may include penalizing the model for getting beyond an outer bound. In some implementations the method may include commencing generation of the 3D head covering from a default mask. In examples, the method includes adding a foundation mask model to a final generation of the 3D head covering to cover up any remaining holes.

In specific examples, the method can include associating a first zone of the plural zones with a respective first indication indicating that the first zone is to be covered, with the first indication being associated with a first weight. Further, this technique may include associating a second zone of the plural zones with a respective second indication indicating that the second zone is to be covered, with the second indication being associated with a second weight. Further still, the method may include associating a third zone of the plural zones with a respective third indication indicating that the third zone is not to be covered. The third indication can be associated with a respective weight that can be the same as the first or second weights or different from the first and second weights. Additional zones and indications with weights may be used.

In another aspect, a processor system is configured to render a mesh using first camera parameters to establish a mesh render, and render a generating shape using the first camera parameters to establish a generating shape render. The system is configured to copy the mesh render and mask the mesh render with the generating shape render so that only the pixels of the mesh render that are uncovered by the generating shape render are visible through the generating shape render. The system is configured to use the mesh render and the generating shape render to represent a loss value. The system is configured to input the loss value to at least one machine learning (ML) model to train the ML model, and receive from the ML model an output shape.

In another aspect, a computer memory that is not a transitory signal includes instructions executable by at least one processor system for identifying indications of plural zones on a mesh as to whether the respective zones are to be covered or uncovered by an output shape, and using the indications and at least one difference between the mesh and an initial neural radiance field (NeRF), generating the output shape for production of a 3D object or image.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates an example initial head mesh;

FIGS. 3-7 illustrate techniques for using a NeRF in conjunction with the head mesh of FIG. 2 to produce an output shape such as a face mask;

FIG. 8 illustrates example initial logic in example flow chart format;

FIG. 9 illustrates example penalty/reward logic in example flow chart format; and

FIG. 10 illustrates example overall logic in example flow chart format.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

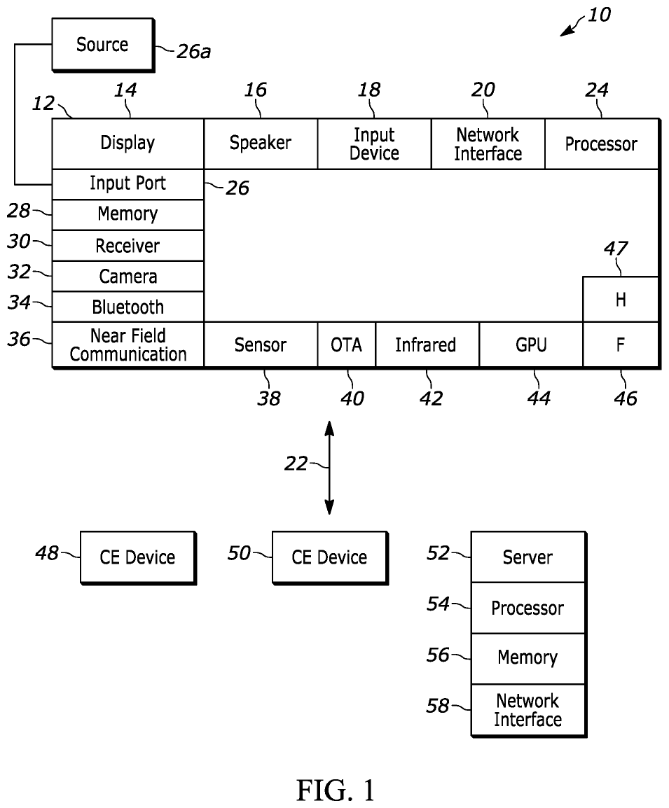

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

In text-to-3D shape generative transformers, present principles understand that some constraints should be imposed on the model, such as requiring that a mask, for instance, fit over a head. Present principles accordingly employ texture-based coverage initialized with a head mesh, in some embodiments formed as a ski mask, with depth data of the mesh being used to limit a NeRF covering the mesh. Plural zones of a head may be used, including four zones as illustrated herein, it being understood that present techniques are not limited to four zones. Specifically, a depth is known for every pixel of the initial mask, so from the same camera view samples are taken between the clipping plane of the camera and the mesh to obtain a render of the front of a NeRF, which is overlaid back onto mesh to see how much is covered, deriving a loss thereby.

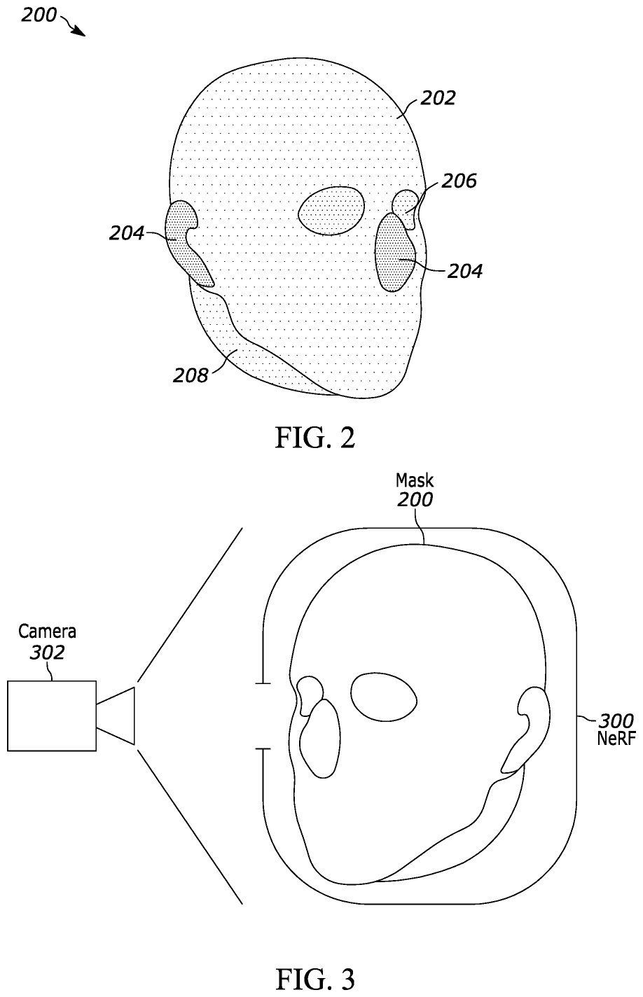

FIGS. 2-7 illustrate. In FIG. 2, a mask 200 has been marked or otherwise designated as having four zones. The zones may be associated with specific RGB channels for illustration. “Red” zone 202 is designated as being a zone to be hidden, i.e., covered by the final render. The yellow zones 204 (in the example shown, nose and ears) are to be hidden with even greater penalty for not hiding them (or greater reward for hiding them) than the red zone 202, in the example shown, a penalty (or reward) twice that of the red zone 202, it being understood that differences in penalties and rewards may be more or less than used in this example.

In contrast, the mask 200 includes one or more blue zones 206 (in the example shown, the eyes) that are associated with an indication (with weight) to be shown through the final render. It is also possible to indicate a green zone 208 that is not associated with any indicator of whether that zone should be covered or not by the final output.

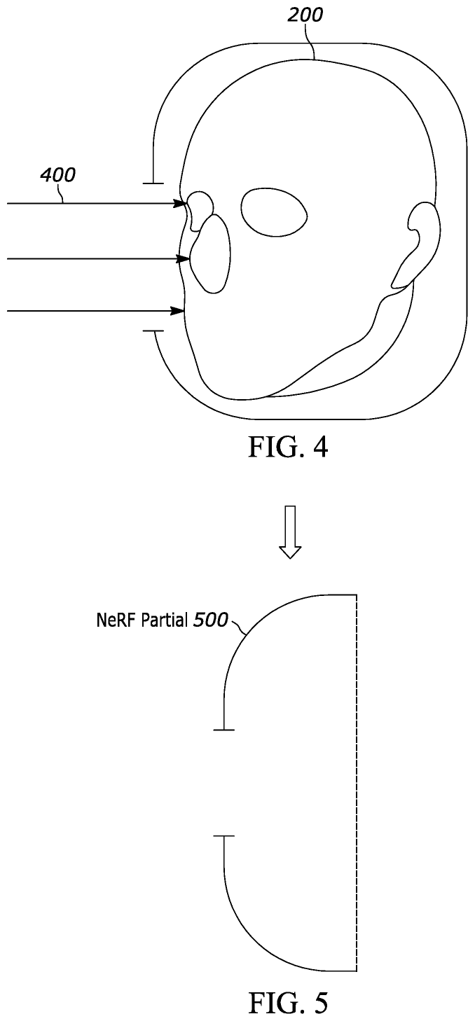

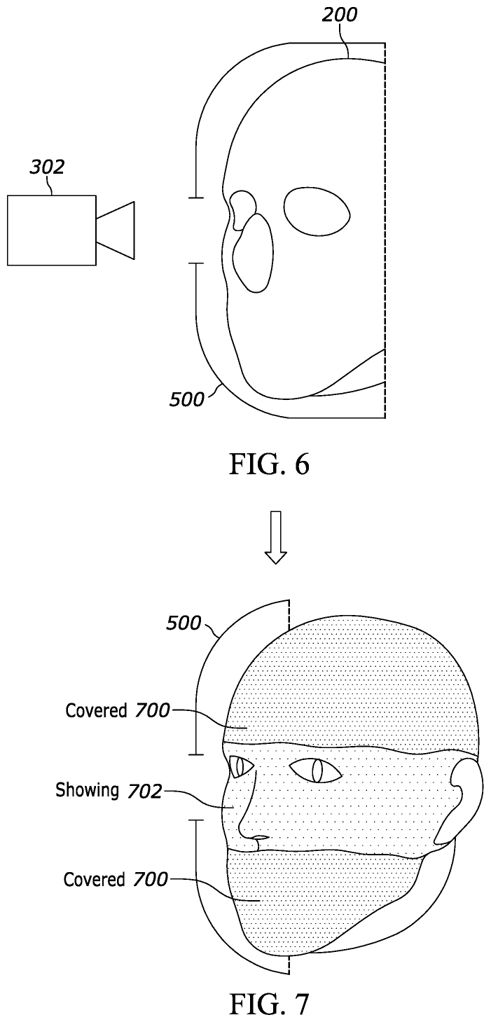

FIGS. 3-7 illustrate rendering the generating shape (currently a neural radiance field, or NeRF) along with the mesh using the same camera parameters. In FIG. 3, a NeRF 300 surrounds a mask such as the mask 200 shown in FIG. 2. A real or simulated camera 302 images the NeRF and mesh to obtain depth information represented by rays 400 in FIG. 4 of the mesh 200. FIG. 5 illustrates that the depth information is used to generate a partial NeRF 500 based on the depth information, which as shown in FIG. 6 is overlaid back over a render of the mask 200 as imaged by the camera 392. This produces regions 700 in FIG. 7 of the mask 200 that are covered by the NeRF as imaged by the camera and regions 702 that are showing through the NeRF.

Thus, the NeRF render uses the mesh render's depth information to only render the NeRF between the camera position and mesh surface (so essentially the parts of the NeRF hidden by the mesh are not seen, as indicated at 500 in FIG. 5). FIG. 6 illustrates that the mesh render is copied and masked with the partial NeRF render 500 so only the pixels of the texture mesh that are “uncovered” by the NeRF can be seen by the camera. The two mesh renders (i.e., covered by the NeRF and not covered by the NeRF, labeled “mesh_image” and “mesh_exposed” in the code below) are used in combination with the indications from FIG. 2 related to penalizing/rewarding correctly covering or showing the zones as indicated to determine the loss for this step in training:

def get_loss(
self, nerf, data, show_lambda=1.0, hide_lambda=1.0, hide_more_lambda=1.0)
   ):
mesh_image, nerf_image, nerf_mask, nerf_outputs=self.get_renders(nerf, data)
mesh_exposed=(1−nerf_mask)*mesh_image
hide_target=mesh_image[ . . . 0]
hide_output=mesh_exposed[ . . . 0]
hide_more_target=mesh_image[ . . . , 0]*mesh_image[ . . . , 1]
hide_more_output=mesh_exposed[ . . . , 0]*mesh_exposed[ . . . , 1]
show_target=mesh_image[ . . . , 2]
show_output=mesh_exposed[ . . . , 2]
hide_loss=hide_output.sum( )/hide_target.sum( )
hide_more_loss=hide_more_output.sum( )/hide_more_target.sum( )
show_loss=(show_target−show_output).sum( )/show_target.sum( )
hide_loss=self.loss_nan_check(hide_loss)
hide_more_loss=self.loss_nan_check(hide_more_loss)
show_loss=self.loss_nan_check(show_loss)
combined_loss=(
   hide_loss*hide_lambda
   +hide_more_loss*hide_more_lambda
   +show loss*show_lambda
)
return combined_loss

The code below illustrates determining loss for regions outside a zone during training. Note that the process represented by the code below obtains plural random points and gets their sigma (essentially transparency), scoring the points based on if they are or are not inside the zone. Only transparent points are desired outside the zone. The scoring is weighted to ensure that only the points outside the zone are accounted for, as the technique does not care if points inside the zone are transparent or not.

class OutsideZoneLoss:
def_init_(self, zone_mesh_fn, center, scale, mesh_scale=0.4):
   mesh=kal.io.obj.import_mesh(
      zone_mesh_fn, with_normals=True, with_materials=True
   )
   self.vertices=(
      (mesh.vertices.cuda( ).unsqueeze(0)−center)/scale*mesh_scale
   )
   self.faces=mesh.faces.cuda( )
def get_loss(self, nerf, num_samples):
   points=torch.rand((num_samples, 3)).cuda( )*2.0−1.0
   sigmas=nerf.density(points)[“sigma”]
   mesh_occ=points_in_mesh(self.vertices, self.faces, points.unsqueeze(0))
   weight=(mesh_occ<0.5).float( )
   mesh_occupancy=torch.zeros_like(sigmas)
   nerf_occ=1−torch.exp(−DELTA*sigmas)
   nerf_occ=nerf_occ.clamp(min=0, max=1.1)
   loss=F.binary_cross_entropy_with_logits(
      nerf_occ, mesh_occupancy, weight=weight, reduction=“sum”
   )
   return loss

With respect to the initial mask, a NeRF blob (basically a sphere) is initialized and then optimized for plural (e.g., 750) steps with the zone and texture shape loss used during normal training, along with one more loss called “sparsity_loss” that's designed to make the NeRF as sparse as possible so it feels like a thin sheet adhering to the face (rather than a thick blob).

When the NeRF is trained a loss is used which permits adding arbitrary loss terms to guide training as long as what generated that loss is differentiable (i.e. pytorch can perform ‘autograd’ on it). Autograd means it can see a function e.g. x\hat{ }2=y and find the differential equation(?) of it e.g. 2×. Present example techniques may thus add a loss term to the standard text-to-3d ‘loss_guidance’ as shown below:

def sparsity_loss (nerf, num_samples):
empty_points=torch.rand((num_samples, 3)).cuda( )*2.0−1.0
sigmas=nerf.density(empty_points)[“sigma”]
   mesh_occupancy=torch.zeros_like(sigmas)
   nerf_occupancy=1−torch.exp(−DELTA*sigmas)
   nerf_occupancy=nerf_occupancy.clamp(min=0, max=1.0)
   loss=F.binary_cross_entropy_with_logits(nerf_occupancy, mesh_occupancy)
   return loss

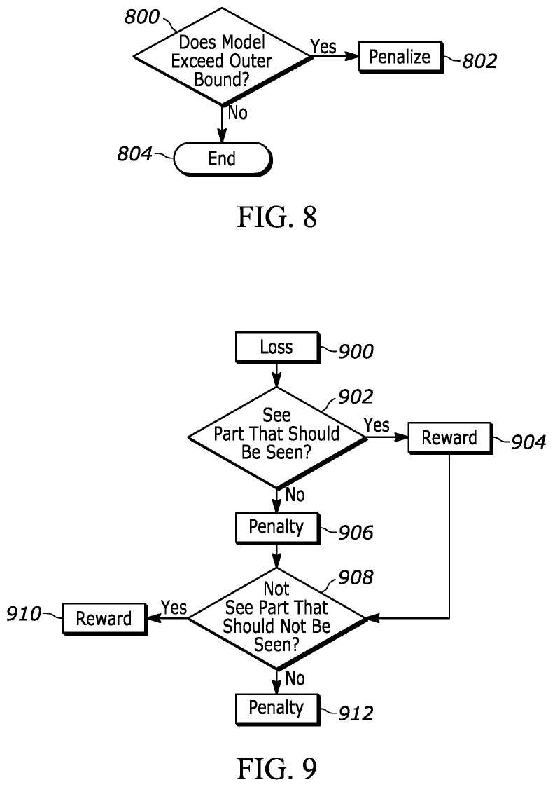

The initial head mesh 200 in FIG. 2 may be initially generated according to the logic of FIG. 8, further details of which are described in the referenced patent application. If it is determined at state 800 that the current model exceeds an outer bound defined by the user, the model is penalized at state 802. Otherwise it not penalized at state 804. The logic of FIG. 8 also may be used in generating the output shape, ensuring it remains within outer bounds.

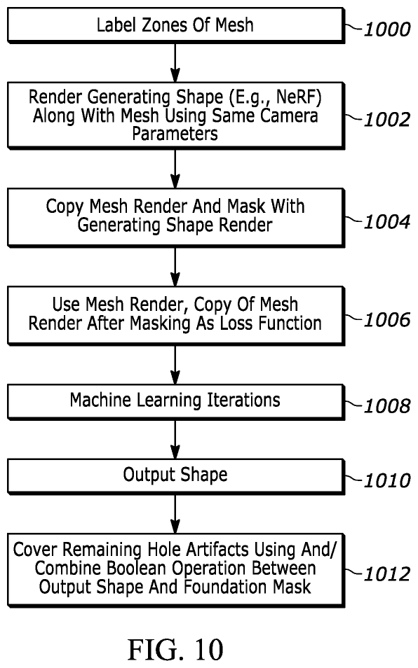

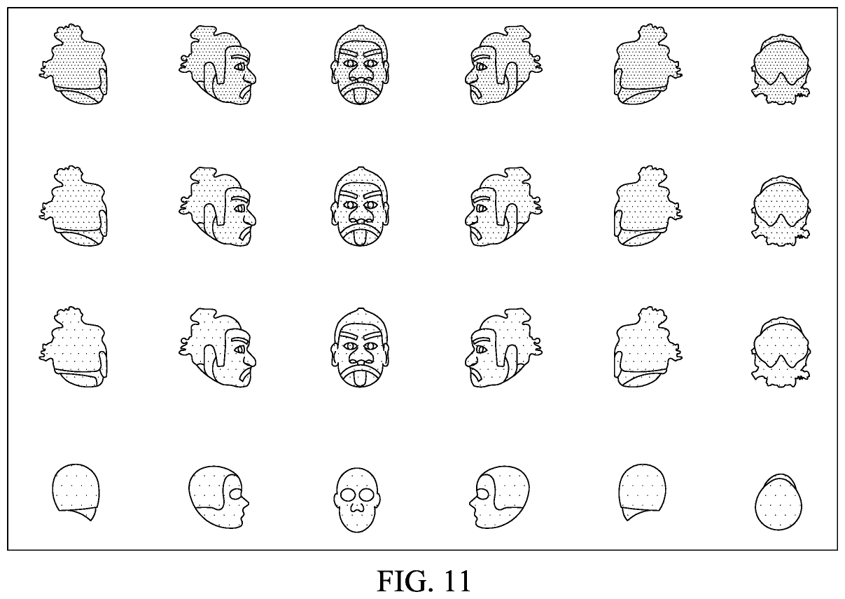

FIGS. 9 and 10 further illustrate principles above. At state 900 in FIG. 9 the indications described in reference to FIG. 2 are identified zone by zone and the two masks compared at state 902 as described above to determine whether a zone (mask part) that should be seen is in fact seen by the camera through the mesh. If it is, a reward is assigned at state 904 according to the weight accorded for that zone described above. If not, a penalty is assigned at state 906 according to the weight accorded for that zone described above.

Similarly, the two masks are compared at state 908 as described above to determine whether a zone (mask part) that should not be seen is in fact not seen by the camera through the mesh. If it is not seen, a reward is assigned at state 910 according to the weight accorded for that zone described above. If the zone is seen, a penalty is assigned at state 912 according to the weight accorded for that zone described above.

FIG. 10 illustrates a higher level flow diagram than FIG. 9. At state 1000 the zones of the initial mesh 200 in FIG. 2 are labeled/assigned weighted values indicating whether they are to be covered or not as described above. Moving to state 1002, the initial generating shape such as the example NeRF is rendered along with the mesh using the same camera parameters for each. The mesh render is copied at state 1004 and masked with the render of the generating shape. At state 1006, using both the mesh render and copy of the mesh render after masking, a loss is determined. State 1008 indicates that this process is iterated in accordance with machine learning techniques to produce an output shape at state 1010 that will form the basis of the object (such as a face mask) being generated.

State 1012 indicates that if desired, any remaining hole artifacts in the output shape from state 1010 may be covered using an AND/Combine Boolean operations between the output shape and a foundation mask.

While the particular embodiments are herein shown and described in detail, it is to be understood that the subject matter which is encompassed by the present invention is limited only by the claims.

What is claimed is:

1. A method comprising:
using a computer, associating plural zones on a target mesh with respective indications each indicating whether the respective zone is to be covered or not covered by a 3D head covering;
using coverage or non-coverage of the zones as a model of the 3D head covering is being generated such that at least one reward in model generation is established for being able to see parts that should be seen and for not being able to see parts that should not be seen and at least one penalty in model generation is established for not being able to see parts that should be seen and for being able to see parts that should not be seen; and
outputting an image of the 3D head covering.

2. The method of claim 1, comprising:
penalizing the model for getting beyond an outer bound.

3. The method of claim 1, comprising:
commencing generation of the 3D head covering from a default mask.

4. The method of claim 1, comprising:
adding a foundation mask model to a final generation of the 3D head covering to cover up any remaining holes.

5. The method of claim 1, comprising associating a first zone of the plural zones with a respective first indication indicating that the first zone is to be covered, the first indication being associated with a first weight.

6. The method of claim 5, comprising associating a second zone of the plural zones with a respective second indication indicating that the second zone is to be covered, the second indication being associated with a second weight.

7. The method of claim 6, comprising associating a third zone of the plural zones with a respective third indication indicating that the third zone is not to be covered, the third indication being associated with a respective weight that is the same as the first or second weights.

8. The method of claim 6, comprising associating a third zone of the plural zones with a respective third indication indicating that the third zone is not to be covered, the third indication being associated with a respective weight that is not the same as the first or second weights.

9. A processor system configured to:
render a mesh using first camera parameters to establish a mesh render;
render a generating shape using the first camera parameters to establish a generating shape render;
copy the mesh render;
mask the mesh render with the generating shape render so that only the pixels of the mesh render that are uncovered by the generating shape render are visible through the generating shape render;
use the mesh render and the generating shape render to represent a loss value;
input the loss value to at least one machine learning (ML) model to train the ML model; and
receive from the ML model an output shape.

10. The processor system of claim 9, wherein the generating shape comprises at least one neural radiance field (NeRF).

11. The processor system of claim 9, wherein the processor system is configured to:
use depth information to establish only portions of the generating shape render between camera position and mesh render surface.

12. The processor system of claim 9, wherein the processor system is configured to:
associate plural zones on the mesh with respective indications each indicating whether the respective zone is to be covered or not covered by the output shape; and
use coverage or non-coverage of the zones as the output shape is generated such that at least one reward in output shape generation is established for being able to see parts that should be seen and for not being able to see parts that should not be seen and at least one penalty in output shape generation is established for not being able to see parts that should be seen and for being able to see parts that should not be seen.

13. The processor system of claim 9, wherein the processor system is configured to:
associate a first zone of the plural zones with a respective first indication indicating that the first zone is to be covered, the first indication being associated with a first weight.

14. The processor system of claim 13, wherein the processor system is configured to:
associate a second zone of the plural zones with a respective second indication indicating that the second zone is to be covered, the second indication being associated with a second weight.

15. The processor system of claim 14, wherein the processor system is configured to:
associate a third zone of the plural zones with a respective third indication indicating that the third zone is not to be covered, the third indication being associated with a respective weight that is the same as the first or second weights.

16. The processor system of claim 14, wherein the processor system is configured to:
associate a third zone of the plural zones with a respective third indication indicating that the third zone is not to be covered, the third indication being associated with a respective weight that is not the same as the first or second weights.

17. A computer memory that is not a transitory signal and that comprises instructions executable by at least one processor system for:
identifying indications of plural zones on a mesh as to whether the respective zones are to be covered or uncovered by an output shape; and
using the indications and at least one difference between the mesh and an initial neural radiance field (NeRF), generating the output shape for production of a 3D object or image.

18. The computer memory of claim 17, wherein the instructions are executable for:
associating a first zone of the plural zones with a respective first indication indicating that the first zone is to be covered, the first indication being associated with a first weight.

19. The computer memory of claim 18, wherein the instructions are executable for:
associating a second zone of the plural zones with a respective second indication indicating that the second zone is to be covered, the second indication being associated with a second weight.

20. The computer memory of claim 19, wherein the instructions are executable for:
associating a third zone of the plural zones with a respective third indication indicating that the third zone is not to be covered, the third indication being associated with a respective weight.
